(19) United States
(12) Patent Application Publication
(10) Pub. No.: US 2012/0220240 A1
(43) Pub. Date: Aug. 30, 2012

(54) RADIO FREQUENCY SELF-CERTIFICATION DEVICES AND METHODS OF USING THE SAME

(75) Inventors: Keith Alan Rothschild, Dunwoody, GA (US); Muhammad Asif Raza, Norcross, GA (US)

(73) Assignee: COX COMMUNICATIONS, INC., Atlanta, GA (US)

(21) Appl. No.: 13/036,329

(22) Filed: Feb. 28, 2011

(51) Int. Cl. H04B 17/00

(52) U.S. Cl. 455/67.11

(57) ABSTRACT

Radio frequency self-certification devices and methods of using the same are provided. A device for testing a radio frequency connection may include at least one radio frequency communications interface, at least one memory, and at least one processor. The at least one memory may be configured to store computer-executable instructions. The at least one processor may be configured to access the at least one memory and execute the computer-executable instructions to (i) scan through a plurality of downstream frequencies received by the communications interface, (ii) collect, based at least in part upon the scan, information associated with a plurality of downstream channels and information associated with available upstream channels, (iii) identify one or more upstream channels that facilitate communication with a host server, and (iv) verify, via the one or more identified upstream channels, the availability of one or more client applications.

### FIELD OF THE INVENTION

Aspects of the invention relate generally to radio frequency connections and more particularly, to devices for testing radio frequency connections.

### BACKGROUND OF THE INVENTION

A wide variety of service providers, such as cable providers and cellular providers, provide various radio frequency services to customers. For example, a cable provider typically provides broadband cable services via a cable network that includes optical fibers and radio frequency cables. In order to receive cable services, a customer typically connects a radio frequency device, such as a cable set-top box, to a radio frequency connection, such as a cable outlet. The customer then utilizes the radio frequency device to receive one or more broadband communication signals output by the cable service provider.

In certain instances, a customer may encounter difficulties when attempting to connect a radio frequency device to a radio frequency connection. Technical difficulties often lead to a relatively time-consuming troubleshooting process and may lead to the dispatch of a service technician to a customer premises. These troubleshooting and customer service procedures are often relatively expensive and result in relatively higher levels of customer dissatisfaction. Accordingly, improved certification devices for testing radio frequency connections may be desirable.

### BRIEF DESCRIPTION OF THE INVENTION

Some or all of the above needs and/or problems may be addressed by certain embodiments of the invention. Embodiments of the invention may include devices for testing radio frequency connections and methods for using the devices. In one embodiment, a device for testing a radio frequency connection may be provided. The device may include at least one radio frequency communications interface, at least one memory, and at least one processor. The at least one memory may be configured to store computer-executable instructions. The at least one processor may be configured to access the at least one memory and execute the computer-executable instructions to (i) scan through a plurality of downstream frequencies received by the communications interface, (ii) collect, based at least in part upon the scan, information associated with a plurality of downstream channels and information associated with available upstream channels, (iii) identify one or more upstream channels that facilitate communication with a host server, and (iv) verify, via the one or more identified upstream channels, the availability of one or more client applications.

In accordance with another embodiment of the invention, a method for testing a radio frequency connection may be provided. A plurality of downstream frequencies received via a radio frequency interface may be scanned by a certification device. Based at least in part upon the scanning, information associated with a plurality of downstream channels and information associated with available upstream channels may be collected by the certification device. One or more upstream channels that facilitate communication with a host server may be identified by the certification device, and the availability of one or more client applications may be verified via the one or more identified upstream channels.

In accordance with yet another embodiment of the invention, a method for utilizing a device to test a radio frequency connection may be provided. A certification device may be connected to a radio frequency port and utilized to scan a plurality of downstream frequencies received via the radio frequency port. Based at least in part upon the scan, information associated with a plurality of downstream channels and information associated with available upstream channels may be collected. The certification device may further be utilized to verify the availability of one or more client applications via the available upstream channels.

Additional systems, methods, apparatus, features, and aspects may be realized through the techniques of various embodiments of the invention. Other embodiments and aspects of the invention are described in detail herein with reference to the description and to the drawings and are considered a part of the claimed invention.

### BRIEF DESCRIPTION OF THE DRAWINGS

Reference will now be made to the accompanying drawings, which are not necessarily drawn to scale, and wherein:

FIG. 1 illustrates a block diagram of an example system that, may be utilized to test a radio frequency connection, according to an illustrative embodiment of the invention.

FIG. 2A illustrates a block diagram of an example self-certification device that may be utilized to test a radio frequency connection, according to an illustrative embodiment of the invention.

FIG. 2B illustrates a block diagram of another example self-certification device that may be utilized to test a radio frequency connection, according to an illustrative embodiment of the invention.

FIG. 3 is a flow diagram of an example method for testing a radio frequency connection, according to an illustrative embodiment of the invention.

FIG. 4 is a flow diagram of an example method for testing downstream channels associated with a radio frequency connection, according to an example embodiment of the invention.

FIG. 5 is a flow diagram of an example method for testing upstream channels associated with a radio frequency connection, according to an example embodiment of the invention.

FIG. 6 is a flow diagram of an example method for testing interactivity with other devices via a local radio frequency network, according to an example embodiment of the invention.

### DETAILED DESCRIPTION OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention may include devices and methods for testing a radio frequency connection. In certain embodiments, a certification device or self-certification device may include at least one radio frequency (“RF”) interface configured to establish an RF connection to be tested. A wide variety of suitable RF interfaces may be included in the self-certification device. For example, a coaxial cable interface may be included in order to test a cable connection. As another example, one or more antennae may be included to test a cellular or other wireless connection.

Once a radio frequency connection has been detected and/or identified, the self-certification device may scan through a plurality of downstream frequencies received via the RF connection and/or the RF interface. Based at least in part upon the scanning, information associated with a plurality of downstream channels may be collected. A wide variety of information associated with downstream channels may be determined. For example, with a cable connection, modulation modes associated with the channels, transport stream layers associated with the channels, and/or data streams associated with the channels may be identified. In certain embodiments, the self-certification device may determine whether each layer associated with a channel (e.g., a modulation mode layer, a transport stream layer, a data stream layer, etc.) is appropriate for the downstream channel. Additionally, as desired, the self-certification device may determine operations modes associated with the downstream channels and/or error correction associated with the downstream channels. As a result of its analyses and determinations, the self-certification device may determine whether the RF connection is properly receiving downstream data.

Additionally, the self-certification device may identify one or more upstream channels that facilitate connection with one or more host servers via the RF connection and any number of intervening networks. In certain embodiments, the one or more upstream channels may be identified based at least in part upon information associated with the plurality of downstream channels. For example, one or more potential upstream channels may be identified or determined, and the self-certification device may test each of the potential upstream channels to determine whether communications can be facilitated via the upstream channel. The self-certification device may also determine whether one or more client applications are available or accessible via the upstream channels.

In certain embodiments, the self-certification device may communicate testing information to one or more external devices, such as a self-certification server or a personal computer. The external devices may analyze or evaluate the testing information and generate a report associated with the operability of the RF connection. As desired, an external device may communicate reports, alerts, error messages, and/or information associated with reports to the self-certification device for output to a user of the device. Alternatively, an external device may output information locally, host information for access by a user, or communicate information to other user devices. As an alternative to communicating testing information to an external device, the self-certification device may optionally process the testing information and generate reports, alerts, and/or information associated with the testing.

Additionally, in certain embodiments, a plurality of self-certification devices may be utilized to test RF network connectivity between two RF connections. For example, a first self-certification device may be connected to a first RF connection associated with a structure, and a second self-certification device may be connected to a second RF connection associated with a structure. The first device may attempt to establish communication with the second device via a local RF network, such as a home area network. In this regard, the local RF network may be tested.

System Overview

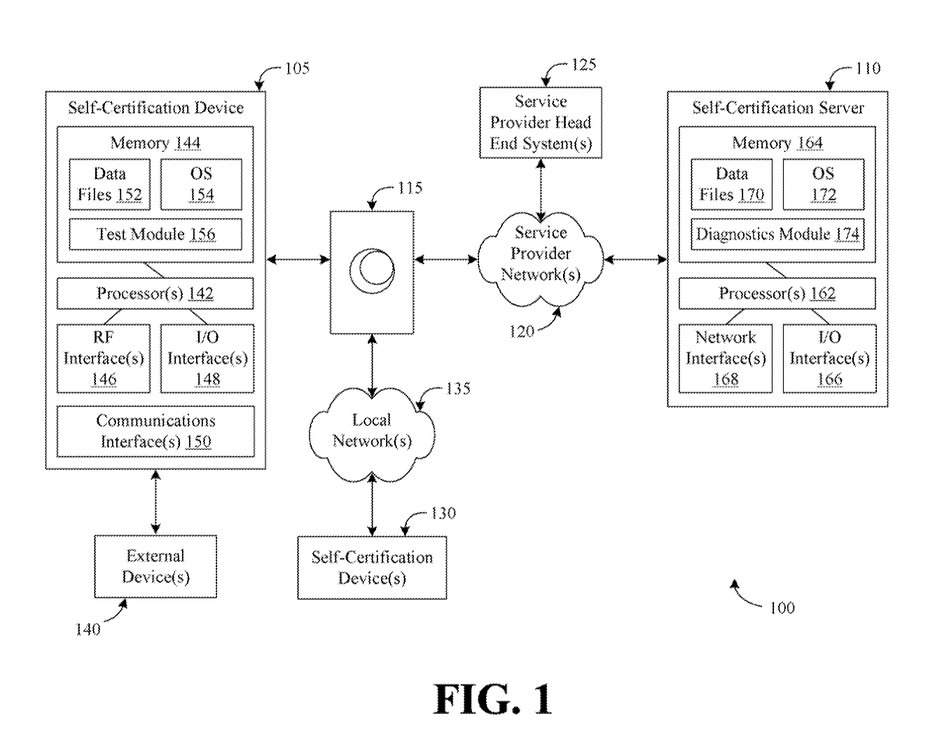

An example system 100 for testing a radio frequency connection will now be described illustratively with respect to FIG. 1. The system 100 may include, for example, a self-certification device 105 and a self-certification server 110. In certain embodiments, the self-certification device 105 may be connected to a radio frequency (“RF”) terminal 115, such as a coaxial cable terminal. In this regard, the self-certification device 105 may be configured to test a radio frequency connection facilitated by the RF terminal 115. During the testing, the self-certification device 105 may evaluate and/or analyze one or more communications signals received by the RF terminal 115. For example, the self-certification device 105 may evaluate a broadband cable signal received by the RF terminal 115 via one or more service provider networks 120, such as a cable network. In certain embodiments, the received signal may be output by one or more service provider systems, such as the service provider head end system(s) 125 illustrated in FIG. 1. For example, the received signal may be output by a cable service provider head end system.

According to an aspect of the invention, the self-certification device 105 may determine whether downstream communications, such as communications output by the service provider head end systems 125, may be received via the RF terminal 115. Additionally, in certain embodiments, the self-certification device 105 may determine whether upstream communications may be transmitted via the RF terminal 115. For example, the self-certification device 105 may determine whether upstream communications may be transmitted to one or more service provider head end systems 125 and/or to the self-certification server 110. Additionally, as desired, the self-certification device 105 may determine whether any number of client applications are available from the head end systems 125.

Additionally, in certain embodiments, the self-certification device 105 may be configured to determine whether communications may be established with any number of additional self-certification devices 130 via the RF connection. For example, a second self-certification device 130 may be connected to a second RF terminal, and the self-certification device 105 may determine whether communications may be established with the second self-certification device 130 via any number of local networks 135, such as a network of in-home cable wiring.

Based upon an analysis of the radio frequency connection, the self-certification device 105 may collect and/or calculate a wide variety of testing information associated with the RF connection. In certain embodiments, the testing information may be utilized by the self-certification device 105 to generate one or more reports associated with the RF connection and/or to generate one or more error messages and/or alerts associated with the RF connection. In other embodiments, at least a portion of the testing information may be communicated to the self-certification server 110 and/or to any number of external devices 140 (e.g., a personal computer executing an analysis application, etc.) for analysis. Following the analysis, in certain embodiments, one or more error messages and/or alerts may be returned to the self-certification device 105 for output or presentation to a user of the device.

FIG. 1 illustrates a system 100 in which a self-certification device 105 is connected to a RF terminal 115 In other words, FIG. 1 illustrates a system 100 in which the self-certification device 105 tests a wired radio frequency connection. In other embodiments, the self-certification device 105 may detect, connect, and/or attempt to connect to a wireless radio frequency network. For example, the self-certification device 105 may include one or more suitable antennae that attempt to connect to a wireless RF network, such as a cellular network. In this regard, the self-certification device 105 may evaluate one or more cellular voice domains, one or more cellular data frequency domains, and/or one or more cellular modulation modes.

With reference to FIG. 1, the self-certification device 105 may be a suitable processor-driven device or component that facilitates the testing of an RF connection. For example, the self-certification device 105 may be a suitable device configured to test, at an RF connection, the receipt of a broadband signal (e.g., a cable signal, etc.) output by a service provider head end system 125 and/or the ability to communicate upstream data to the head end system 125. As another example, the self-certification device 105 may be a suitable device configured to test the receipt of a cellular signal via an RF connection. The self-certification device 105 may include any number of computing devices, such as a personal computer, a digital assistant, a personal digital assistant, a digital tablet, an Internet appliance, an application-specific circuit, a microcontroller, a minicomputer, or any other processor-based device. The execution of suitable computer-implemented instructions or computer-executable instructions by the self-certification device 105 may form a special purpose computer or other particular machine that is operable to facilitate the testing of an RF connection.

With reference to FIG. 1, the self-certification device 105 may include one or more processors 142, one or more memory devices 144, one or more RF interfaces 146, one or more input/output (“I/O”) interfaces 148, and/or one or more communications interfaces 150. The processors 142 may be configured to execute any number of software applications and/or computer-readable or computer-executable instructions. The memory devices 144 may include any number of suitable memory devices, such as caches, read-only memory devices, random access memory devices, flash memory devices, magnetic storage devices, removable storage devices (e.g., memory cards, etc.), etc. The memory devices 144 may store data, executable instructions, and/or various program modules utilized by the processors 142, such as data files 152, an operating system (“OS”) 154, and/or a test module 156.

The data files 152 may include any suitable data that facilitates the operation of the self-certification device 105, the testing of an RF connection, and/or the presentation of testing and/or alert data to a user of the self-certification device 105. For example, the data files 152 may include, but are not limited to, information associated with the types of tests to be performed by the self-certification device 105, information associated with the self-certification server 110, information associated with one or more service provider head end systems 125, measurements and testing information, alerts and/or alert messages generated or received by the self-certification device 105, and/or testing report information. The OS 154 may be a suitable software module that controls the general operation of the self-certification device 105. The OS 154 may also facilitate the execution of other software modules, for example, the test module 156.

The test module 156 or test application may be a suitable software module that executes or implements computer-executable instructions to facilitate the testing of an RF connection. A wide variety of suitable methods and/or techniques may be utilized by the test module 156 to facilitate testing of an RF connection, such as an RF connection formed between the self-certification device 105 and the RF terminal 115. For example, in certain embodiments, the test module 156 may coordinate the scanning of a plurality of downstream frequencies received via an RF interface 146 via the RF connection. Based at least in part upon the scanning, the test module 156 may identify and collect information associated with a plurality of available downstream channels. Additionally, the test module 156 may facilitate the testing and/or verification of a wide variety of information associated with each of the downstream channels. In certain embodiments, the test module 156 may test downstream channels at a plurality of different levels. For example, with a cable connection, the test module 156 may identify, test, and/or verify a modulation mode associated with a downstream channel, one or more transport stream layers associated with the downstream channel, one or more data streams associated with the downstream channel, and/or error correction associated with the downstream channel. In the event that any errors are identified by the test module 156, the test module 156 may determine a level at which the error occurred (e.g., a modulation mode error, a transport stream layer error, etc.). In this regard, troubleshooting may be simplified as a result of isolating errors. As desired, the test module 156 may store testing information and/or generate alerts and/or error messages associated with the testing.

Additionally, during testing, the test module 156 may identify one or more upstream channels that facilitate communication with one or more host servers, such as host servers associated with the service provider head end systems 125. In certain embodiments, potential upstream channels may be identified based at least in part upon the information collected for the downstream channels, and each upstream channel may be tested in order to determine whether communications are facilitated via the upstream channel. Additionally, the test module 156 may test the availability of a wide variety of client or user applications via the upstream channels. For example, in a cable system, the test module 156 may determine whether an electronic program guide application, a video on demand application, a switched digital video application, a mini-carousel application, an Internet television application, a benchmark application, and/or other applications are available via one or more of the upstream channels. In this regard, the test module 156 may test and/or verify upstream connectivity for the RF connection. As desired, the test module 156 may store testing information and/or generate alerts and/or error messages associated with the testing.

As desired in certain embodiments, the test module 156 may also test network connectivity with one or more additional self-certification devices 130 via one or more suitable local networks 135. For example, a first self-certification device 105 may be connected to a first RF terminal 115 within a structure, and a second self-certification device may be connected to a second RF terminal within the structure. The test module 156 may determine whether a connection may be formed between the two self-certification devices via the RF terminals and the local network. The test module 156 may test for a wide variety of different connections as desired in various embodiments, such as a Multimedia over Coax Alliance (“MoCA”) connection. Additionally, the test module 156 may store testing information and generate alerts and/or error messages associated with the testing.

In certain embodiments, the test module 156 may selectively store information, data, and/or generated alerts associated with the testing of the RF connection. As desired, test module 156 may direct communication of at least a portion of the stored testing information to one or more self-certification servers 110 and/or external devices 140 for processing. For example, testing information may be communicated to the self-certification server 110 for additional processing. As another example, testing information may be communicated or output to a personal computer executing one or more suitable software programs that facilitate further processing of the testing information. Following the further processing by a diagnostics module 174 associated with a self-certification server 110 or an external device 140, any number of messages and/or instructions may be communicated to the test module 156, and the test module 156 may process the received messages and/or instructions. As desired, the test module 156 may format any number of messages for output or other presentation to a user of the self-certification device 105. As an alternative to communicating testing information, in certain embodiments, the test module 156 may generate one or more reports based upon collected data and/or output messages for presentation to users of the self-certification device 105.

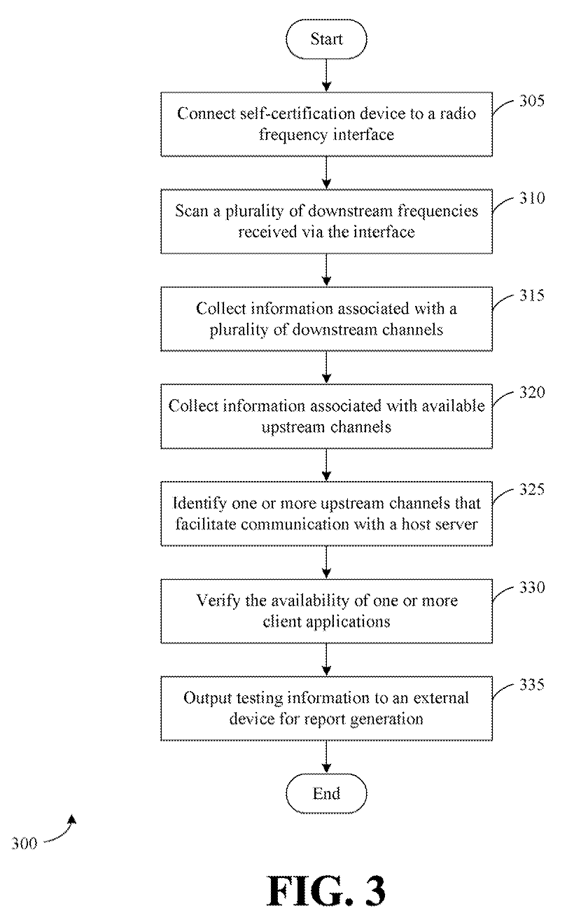

A wide variety of suitable operations may be performed by the test module 156 to facilitate the testing of an RF connection. The operations described above are provided by way of example only. Additional examples of the operations that may be performed by the test module 156 are described in greater detail below with reference to FIGS. 3-6.

With continued reference to the self-certification device 105, the one or more RF interfaces 146 may facilitate the identification and/or establishment of an RF connection by the self-certification device 105. In this regard, the RF connection may be tested by the self-certification device 105. A wide variety of suitable RF interfaces 146 may be utilized as desired in various embodiments of the invention. For example, a coaxial cable termination and/or coaxial cable may facilitate connection with an RF terminal. As another example, one or more antennae may facilitate wireless RF connectivity. As desired, an antenna may be tuned to operate within a desired frequency range, such as a frequency range associated with cellular voice and/or data domains.

The I/O interfaces 148 may facilitate communication between the self-certification device 105 and one or more input/output devices, for example, one or more user interface devices, such as a display, keypad, control panel, touch screen display, microphone, speaker, etc., that facilitate user interaction with the self-certification device 105. In this regard, user commands may be received by the self-certification device 105 and various messages, instructions and/or alerts may be output for presentation. The one or more communications interfaces 150, which may be optional in certain embodiments, may facilitate connection of the self-certification device 105 to any number of external devices 140 and/or networks, such as any number of local area networks (e.g., a Bluetooth-enabled network, a Wi-Fi enabled network, a wired local area network, etc.). In this regard, the self-certification device 105 may output testing information and/or receive messages associated with the additional processing of the testing information.

With continued reference to FIG. 1, the self-certification server 110 may be a suitable processor-driven device or component that facilitates the processing and/or evaluation of testing data received from any number of self-certification devices. The self-certification server 110 may include any number of computing devices, such as a personal computer, a server computer, a plurality of networked computers, or any other suitable processor-based device and/or combination of devices. The execution of suitable computer-implemented instructions or computer-executable instructions by the self-certification server 110 may form a special purpose computer or other particular machine that is operable to facilitate the receipt of testing information, the analysis and/or processing of the received testing information, the generation of one or more reports, instructions, error messages, and/or alerts associated with testing the RF connections, and/or the communication of reports, messages, and/or alerts to self-certification devices.

With reference to FIG. 1, the self-certification server 110 may include one or more processors 162, one or more memory devices 164, one or more input/output (“I/O”) interfaces 166, and/or one or more network or communications interfaces 168. The processors 162 may be configured to execute any number of software applications and/or computer-readable or computer-executable instructions. The memory devices 164 may include any number of suitable memory devices, such as caches, read-only memory devices, random access memory devices, flash memory devices, magnetic storage devices, removable storage devices (e.g., memory cards, etc.), etc. The memory devices 164 may store data, executable instructions, and/or various program modules utilized by the processors 162, such as data files 170, an operating system (“OS”) 172, and/or a diagnostics module 174.

The data files 170 may include any suitable data that facilitates the operation of the self-certification server 110, the evaluation or analysis of testing information, the generation of reports, alerts, messages, and/or instructions, and/or the communication of generated messages to self-certification devices. For example, the data files 170 may include, but are not limited to, information associated with one or more self-certification devices, testing information received from one or more self-certification devices, expected data values for various RF connections, alerts and/or messages generated by the self-certification server 110, and/or reports generated by the self-certification server 110. The OS 172 may be a suitable software module that controls the general operation of the self-certification server 110. The OS 172 may also facilitate the execution of other software modules, for example, the diagnostics module 174.

The diagnostics module 174 or diagnostics application may be a suitable software module that executes or implements computer-executable instructions to facilitate the analysis of testing information received from one or more self-certification devices. In operation, the diagnostics module 174 may receive testing information output by a self-certification device 105 and associated with an RF connection. In certain embodiments, testing information may be received via one or more service provider networks 120, such as a cable network or a cellular network. In other embodiments, testing information may be received via one or more other networks and/or connections. For example, a self-certification server 110 associated with a cable provider may receive testing information from a self-certification device 105 via a cellular network or other non-service provider network.

As desired in certain embodiments, the diagnostics module 174 may analyze or evaluate at least a portion of the received testing information in order to determine whether the RF connection is functioning properly. For example, measurements data received from a self-certification device 105 may be processed in order to determine whether the RE connection is functioning properly. Similarly, testing information may be evaluated in order to determine whether a local connection between two or more self-certification devices is functioning properly. As desired, a wide variety of errors may be identified by the diagnostics module 174, such as errors associated with any number of downstream or upstream channels, and/or errors associated with any layer of connectivity for a channel. In certain embodiments, the diagnostics module 174 may generate reports, such as diagnostics reports, associated with an RF connection. As desired, generated reports and/or messages including information associated with identified or generated errors may be communicated to a self-certification device 105. In this regard, diagnostics information may be output by the self-certification device 105 for presentation to a user. A wide variety of information may be included in generated reports and/or messages as desired in various embodiments of the invention, such as diagnostic information associated with any number of upstream and/or downstream channels, identified errors, and/or troubleshooting instructions associated with identified errors. Additionally, the diagnostics module 174 may direct the storage of at least a portion of the received testing data, generated reports, generated alerts, and/or generated messages. In this regard, a service provider may subsequently access generated reports and/or messages to analyze or evaluate RF connections.

With continued reference to the self-certification server 110, the one or more I/O interfaces 166 may facilitate communication between the self-certification server 110 and one or more input/output devices, for example, one or more user interface devices, such as a display, keypad, control panel, mouse, touch screen display, microphone, speaker, etc., that facilitate user interaction with the self-certification server 110. In this regard, user commands may be received by the self-certification server 110, and various data may be output for presentation. The one or more network interfaces 168 or communications interfaces may facilitate connection of the self-certification server 110 to any number of networks, such as the service provider networks 120. In this regard, the self-certification server 110 may receive testing information and/or output messages and/or reports associated with the processing of the received testing information.

With continued reference to FIG. 1, the RF terminal 115 may be any suitable RF terminal configured to facilitate the establishment of an RF connection. For example, the RF terminal may be a coaxial cable terminal or outlet, such as a cable outlet within a home. A self-certification device 105 may be connected to the RF terminal 115 via a suitable coaxial cable. Although an RF terminal 115 is illustrated in FIG. 1, certain embodiments of the invention may include a self-certification device 105 configured to evaluate or test a wireless RF connection, such as a cellular connection. Accordingly, certain embodiments of the invention may not include an RF terminal 115.

With continued reference to FIG. 1, any number of service provider head end systems 125 may be provided. These systems 125 may include any number of systems, components, and/or devices that facilitate the provision of services to customers of the service provider. For example, systems 125 associated with a cable service provider may include, but are not limited to, one or more components that output broadband signals, one or more encoders, one or more electronic guide data servers, one or more video on demand servers, one or more switched digital video servers, one or more Internet servers, etc. As another example, systems 125 associated with a cellular service provider may include, but are not limited to, content distribution servers, account management servers, switching servers, etc. In certain embodiments, a service provider head end system 125 may output data that may be received by self-certification devices 105. For example, an electronic guide data server may output electronic guide data that may be received and/or identified by a self-certification device 105. Additionally, a service provider head end system 125 may receive, process, and respond to requests output by various self-certification devices 105. For example, a self-certification device 105 may request the establishment of a video on demand session with a video on demand server, and the video on demand server may communicate video on demand information to the self-certification device 105 in response to the request. In this regard, the self-certification device 105 may determine whether a video on demand application is available via an RF connection that is being tested.

Communications between various components of the system 100 may be facilitated via any number of suitable networks, such as one or more service provider networks (e.g., a cable network, etc.) 120 and/or any number of local networks 135. The service provider networks 120 may include any telecommunication and/or data networks, whether public, private, or a combination thereof, including but not limited to, a cable network, a cellular network, and/or other service provider networks. According to an aspect of the invention, at least a portion of the service provider networks 120 may include a radio frequency network. The local networks 135 may include any local networks that facilitate communication between two self-certification devices 105, such as a home area network, an in-home radio frequency network, etc.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1.

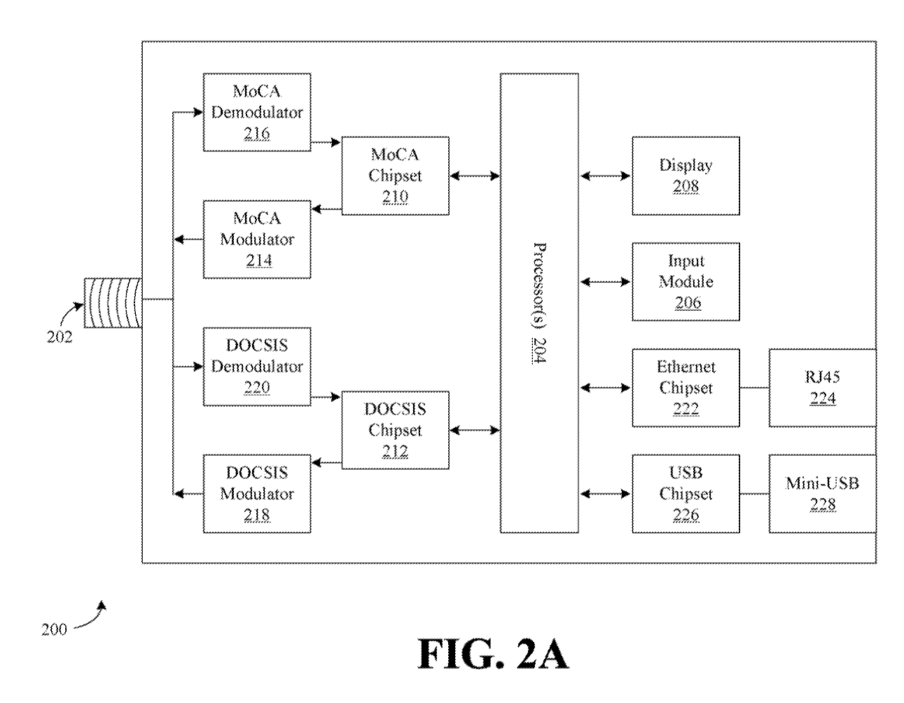

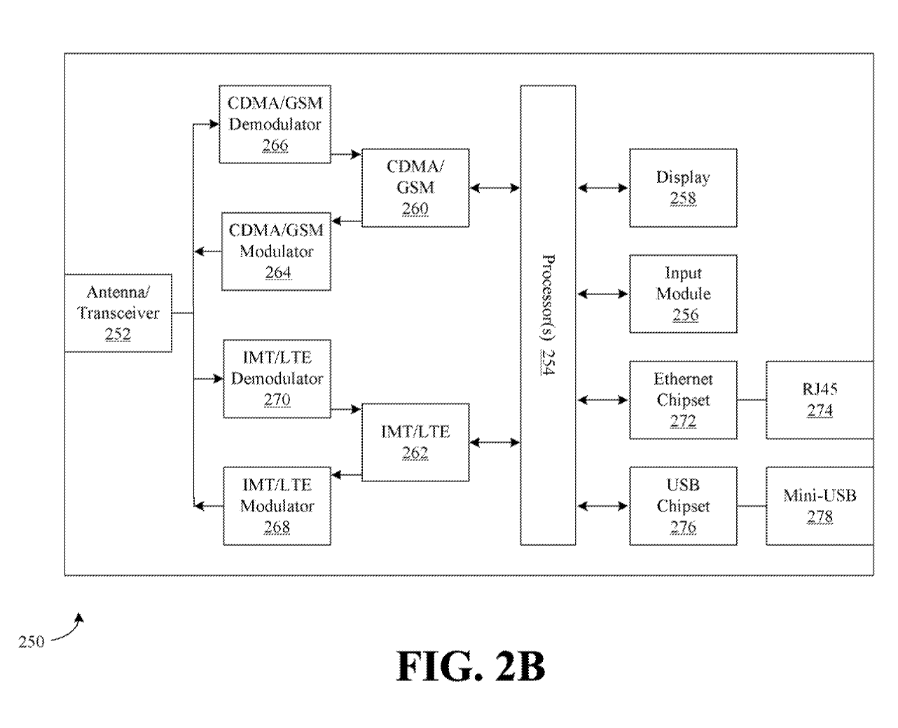

FIG. 2A illustrates a block diagram of an example self-certification device 200 that may be utilized to test a radio frequency connection, according to an illustrative embodiment of the invention. The self-certification device 200 shown in FIG. 2A may be one example of the self-certification device 105 described above with reference to FIG. 1. The self-certification device 200 is one example of a device that may be utilized to test a wired RF connection, such as a cable connection. In operation, the self-certification device 200 may be connected to a cable outlet in order to test the RF connection provided by the cable outlet.

With reference to FIG. 2A, the self-certification device 200 may include an RF interface 202, one or more processors 204, one or more chipsets, one or more modulators and/or demodulators, an input module 206, and/or a display 208. The RF interface 202 may be any suitable interface configured to facilitate connection to an RF terminal (e.g., a cable outlet, etc.) in order to test an RF connection. For example, the RF interface 202 may include a coaxial terminator that allows a coaxial cable to be connected between the RF terminal and the self-certification device 200. As another example, the RF interface 202 may include a coaxial cable with a male plug configured to be connected to the RF terminal.

The one or more processors 204 may include any suitable processors configured to execute computer-executable instructions that facilitate the testing and/or evaluation of an RF connection. The input module 206 may include any number of suitable interfaces that facilitate the receipt of user commands by the self-certification device 200. For example, the input module 206 may include a touch screen interface and/or a keypad interface that facilitates the receipt of user commands. The display 208 may be any suitable display that facilitates the presentation of testing information, reports, selectable options, and/or other information to a user of the self-certification device 200. Examples of suitable displays may include, but are not limited to, a liquid crystal display (“LCD”) or a light-emitting diode (“LED”) display. Additionally, any number of suitable display drivers may be incorporated into the self-certification device 200. As desired, other input and/or output devices, such as a microphone, a speaker, and/or other suitable devices, may he incorporated into the self-certification device 200.

According to an aspect of the invention, the self-certification device 200 may include any number of chipsets, modulators, and/or demodulators that facilitate receipt of information via an RF connection and/or the transmission of information via the RF connection. As shown in FIG. 2A, the self-certification device 200 may include a Multimedia over Coax Alliance (“MoCA”) chipset 210 and a Data Over Cable Service Interface Specification (“DOCSIS”) chipset 212. These chipsets may respectively facilitate the processing of MoCA and DOCSIS communications and/or signals by the self-certification device 200. Each chipset may include an associated modulator and/or demodulator that facilitate the receipt and/or output of communications. For example, a MoCA modulator 214 and a MoCA demodulator 216 may be associated with the MoCA chipset 210. Similarly, a DOCSIS modulator 218 and a DOCSIS demodulator 220 may be associated with the DOCSIS chipset 212. The demodulators may facilitate the identification and extraction of relevant information from a signal received via the RF interface 202. For example, the DOCSIS demodulator 220 may facilitate the extraction of DOCSIS-formatted information received in a broadband communication signal. Similarly, the modulators may facilitate the addition of information to an upstream signal accessible to and/or output by the self-certification device 200. For example, the DOCSIS modulator 218 may facilitate the addition of information to one or more upstream DOCSIS channels.

The MoCA and DOCSIS chipsets 210, 212 and their corresponding modulators and demodulators are provided by way of example only. As desired, other chipsets may be incorporated into the self-certification device 200, such as an Amplitude Modulation-Vestigial Side-Band (“AM-VSB”) chipset, a quadrature amplitude modulation (“QAM”) chipset, a quadrature phase-shift keying (“QPSK”) chipset, a time division multiple access (“TDMA”) chipset, a code division multiple access (“CDMA”) chipset, and/or an orthogonal frequency-division multiplexing (“OFDM”) chipset. Additionally, suitable modulation and/or demodulation components may be associated with each of these chipsets.

In certain embodiments, the self-certification device 200 may include one or more components that facilitate communications between the self-certification device 200 and one or more external devices. For example, the self-certification device 200 may include an Ethernet chipset 222 that facilitates Ethernet connectivity. In this regard, the self-certification device 200 may communicate with other Ethernet-enabled devices, such as a personal computer. In certain embodiments, a suitable Ethernet termination 224, such as an RJ45 jack or plug, may be provided. In other embodiments, a wireless transceiver may facilitate network connectivity. With continued reference to FIG. 2A, a Universal Serial Bus (“USB”) chipset 226 may additionally or alternatively be provided to facilitate communication between the self-certification device 200 and any number of external devices. As desired, the self-certification device 200 may additionally include a suitable USB port or mini-USB port 228 that facilitates connection of the self-certification device 200 to a USB cable and/or USB devices (e.g., thumb drives, etc.). In this regard, the self-certification device 200 may output and/or receive data via a USB connection.

FIG. 213 illustrates a block diagram of another example self-certification device 250 that may be utilized to test a radio frequency connection, according to an illustrative embodiment of the invention. The self-certification device 250 shown in FIG. 2B may be another example of the self-certification device 105 described above with reference to FIG. 1. The self-certification device 250 is one example of a device that may be utilized to test a wireless RF connection, such as a telephone connection. In operation, the self-certification device 250 may wireless connect to a radio frequency network (e.g., a cellular network, etc.) in order to test the RF connection provided by the network.

With reference to FIG. 2B, the self-certification device 250 may include one or more antennae and/or transceivers 252, one or more processors 254, one or more chipsets, one or more modulators and/or demodulators, an input module 256, and/or a display 258. The one or more antennae and/or transceivers 252 may be any suitable components configured to facilitate connection to a wireless RF network, such as a cellular network.

The one or more processors 254 may include any suitable processors configured to execute computer-executable instructions that facilitate the testing and/or evaluation of an RF connection. The input module 256 may include any number of suitable interfaces that facilitate the receipt of user commands by the self-certification device 250. For example, the input module 256 may include a touch screen interface and/or a keypad interface that facilitates the receipt of user commands. The display 258 may be any suitable display that facilitates the presentation of testing information, reports, selectable options, and/or other information to a user of the self-certification device 250. Examples of suitable displays may include, but are not limited to, a liquid crystal display (“LCD”) or a light-emitting diode (“LED”) display. Additionally, any number of suitable display drivers may be incorporated into the self-certification device 250. As desired, other input and/or output devices, such as a microphone, a speaker, and/or other suitable devices, may be incorporated into the self-certification device 250.

According to an aspect of the invention, the self-certification device 250 may include any number of chipsets, modulators, and/or demodulators that facilitate receipt of information via an RF connection and/or the transmission of information via the RF connection. As shown in FIG. 2B, the self-certification device 250 may include a Code Division Multiple Access (“CDMA”)/Global System for Mobile Communications (“GSM”) chipset 260 and an international Mobile Telecommunications (“IMT”)/Long Term Evolution (“LTE”) chipset 262. These chipsets may respectively facilitate the processing of CDMA/GSM and IMT/LTE communications and/or signals by the self-certification device 250. Each chipset may include an associated modulator and/or demodulator that facilitate the receipt and/or output of communications. For example, a CDMA/GSM modulator 254 and a CDMA/GSM demodulator 256 may be associated with the CDMA/GSM chipset 260. Similarly, an IMT/LTE modulator 268 and an IMT/LTE demodulator 270 may be associated with the IMT/LTE chipset 262. The demodulators may facilitate the identification and extraction of relevant information from a signal received via the one or more antenna and/or transceivers. Similarly, the modulators may facilitate the addition of information to an upstream signal accessible to and/or output by the self-certification device 250.,

The CDMA/LTE and IMT/LTE chipsets 260, 262 and their corresponding modulators and demodulators are provided by way of example only. As desired, other chipsets may be incorporated into the self-certification device 250, such as TDMA chipsets other than a GSM chipset and/or an Institute of Electrical and Electronics Engineers (“IEEE”) 802-based chipset (e.g., a wireless personal area network chipset, a Worldwide Interoperability for Microwave Access (“WiMAX”) chipset, etc.). Additionally, suitable modulation and/or demodulation components may be associated with each of these chipsets.

In certain embodiments, the self-certification device 250 may include one or more components that facilitate communications between the self-certification device 250 and one or more external devices. For example, the self-certification device 250 may include an Ethernet chipset 272 that facilitates Ethernet connectivity. in this regard, the self-certification device 250 may communicate with other Ethernet-enabled devices, such as a personal computer. In certain embodiments, a suitable Ethernet termination 274, such as an RJ45 jack or plug, may be provided. In other embodiments, a wireless transceiver may facilitate network connectivity. With continued reference to FIG. 2B, a Universal Serial Bus (“USB”) chipset 276 may additionally or alternatively be provided to facilitate communication between the self-certification device 250 and any number of external devices. As desired, the self-certification device 250 may additionally include a suitable USB port or mini-USB port 278 that facilitates connection of the self-certification device 250 to a USB cable and/or USB devices (e.g., thumb drives, etc.). In this regard, the self-certification device 250 may output and/or receive data via a USB connection.

Additionally, in certain embodiments, the self-certification device may include a suitable Global Positioning System (“GPS”) component or other suitable positional locator. A positional locator may facilitate the determination of positional information for the self-certification device that may be utilized to identify appropriate downstream and/or upstream channels and/or to access desired client applications.

Those of ordinary skill in the art will appreciate that the self-certification devices 200, 250 shown in and described with respect to FIGS. 2A-2B are provided by way of example only. Numerous other device configurations are possible. Other devices can include fewer or greater numbers of components and may incorporate some or all of the functionality described with respect to the system components shown in FIGS. 2A-2B.

Operational Overview

FIG. 3 is a flow diagram of an example method 300 for testing a radio frequency connection, according to an illustrative embodiment of the invention. In certain embodiments, the method 300 may be performed by a suitable self-certification device, such as the self-certification device 105 illustrated in FIG. 1 or the self-certification devices 200, 250 illustrated in FIGS. 2A-2B. The method 300 may begin at block 305.

At block 305, the self-certification device 105 may be connected to a radio frequency interface or to a radio frequency terminal. For example, a suitable coaxial cable may be utilized to connect the self-certification device 105 to a cable outlet or RF plug. As another example, a suitable RF antenna associated with the self-certification device 105 may be utilized to identify and interface with a wireless radio frequency network, such as a cellular network.

At block 310, a plurality of downstream frequencies received via the radio frequency interface may be scanned. Utilizing a cable connection as an example, a plurality of downstream frequencies may be scanned in order to identify and/or collect information associated with a plurality of downstream channels. For example, a plurality of downstream frequencies included in a broadband signal output by a cable service provider may be scanned. Utilizing a cellular connection as another example, a plurality of frequencies associated with a cellular voice and/or data communications may be scanned in order to collect information associated with a cellular connection. Each identified downstream channel may be associated with a range of frequencies that are scanned. For example, with a cable connection, each downstream channel may have an identified bandwidth, such as a bandwidth of approximately four megahertz, approximately six megahertz, or another suitable bandwidth. As desired in certain embodiments, different channels may be associated with different bandwidths. Additionally, in certain embodiments, the bandwidths of channels may he variable. For example, a block of channels may be bonded together, and a given bandwidth for the block of channels may be shared.

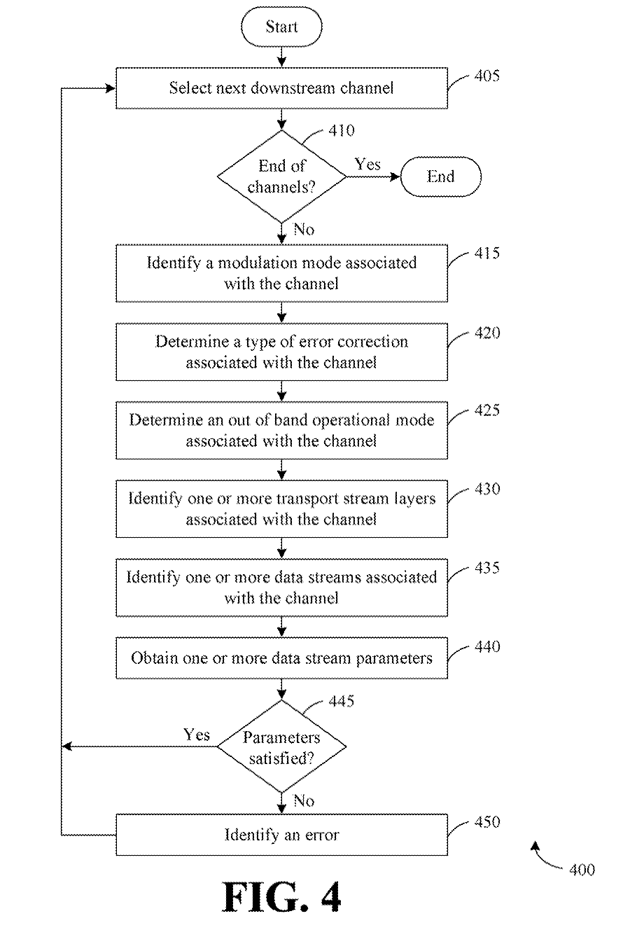

At block 315, information associated with the plurality of downstream channels may be collected. A wide variety of information associated with the downstream channels may be collected as desired in various embodiments of the invention. For example, with a cable connection, modulation mode information, transport stream layer information, data stream information, and/or error correction information may be collected. In certain embodiments, various layers associated with a downstream channel may be tested, and information associated with each of the layers may be collected and/or verified. One example of the operations that may be performed at block 315 is described in greater detail below with reference to FIG. 4.

At block 320, information associated with one or more available upstream channels may be collected. In certain embodiments, one or more available upstream channels may be identified based at least in part upon the information collected for the plurality of downstream channels. For example, one or more out-of-band upstream channels may be identified based at least in part upon information associated with identified in-band downstream channels. As another example, if one or more downstream DOCSIS channels are identified, then one or more upstream DOCSIS paths or channels may be identified as potentially available upstream channels. As yet another example, if a Society of Cable Telecommunications Engineers (“SCTE”) downstream channel is identified, then one or more SCTE upstream channels (e.g., SCTE 55-1, SCTE 55-2, etc.) may be identified as potentially available channels.

At block 325, one or more upstream channels that facilitate communication with one or more host servers, such as the service provider head end systems 125 and/or the self-certification server 110 illustrated in FIG. 1, may be identified and/or tested. For example, the self-certification device 105 may test each potential upstream channel and, based at least in part upon the testing, the self-certification device 105 may identify or determine one or more upstream channels that facilitate communication with the host servers. In the event that an upstream channel does not facilitate communication, the self-certification device 105 may identify an error associated with the upstream channel and/or network connectivity via the upstream channel. Additionally, the self-certification device 105 may collect information associated with each of the upstream channels in a similar manner as that described above for the downstream channels.

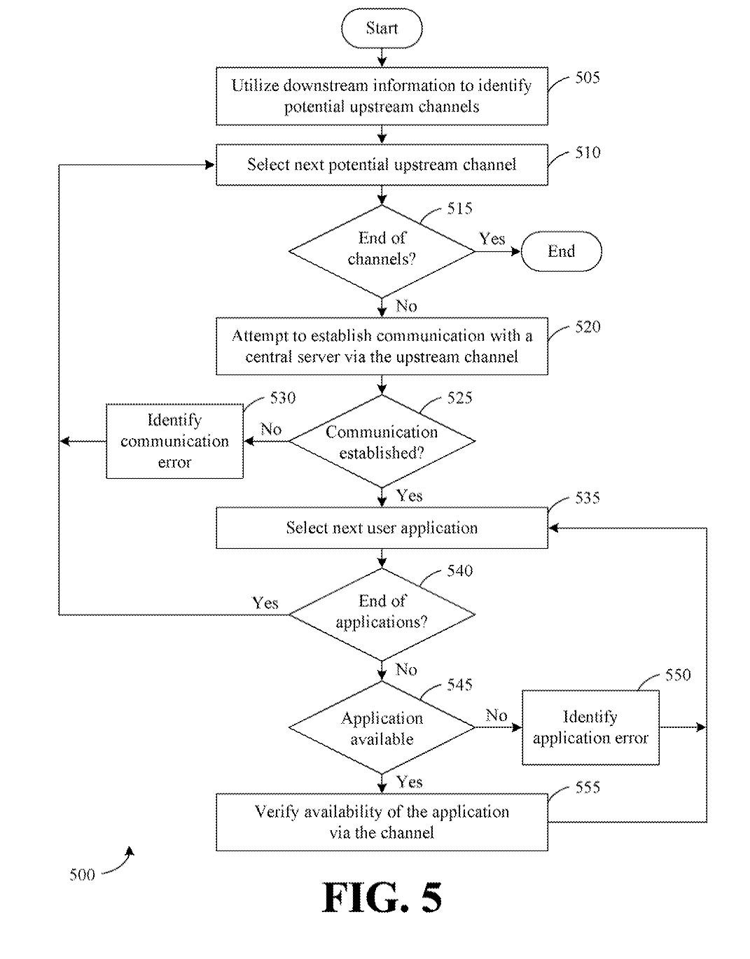

At block 330, the self-certification device 105 may test and/or verify the availability of one or more client applications via the one or more upstream channels. For example, the self-certification device 105 may identify one or more client applications that make use of communication with one or more host servers, and the self-certification device 105 may identify one or more upstream channels that may facilitate communications for the application. For each client application, the self-certification device 105 may then test each of the identified upstream channels for connectivity. The self-certification device 105 may collect information associated with each of the applications based upon the testing. A. wide variety of suitable client applications may be tested as desired in various embodiments of the invention. For example, with a cable connection, an electronic program guide application, a video on demand application, a mini-carousel application, an Internet television application, and/or a bookmark application may be tested. One example of the operations that may be performed at blocks 320-330 is described in greater detail below with reference to FIG. 5.

At block 335, which may be optional in certain embodiments of the invention, testing information collected by the self-certification device 105 may be output for receipt by any number of external devices, such as the self-certification server 110 or a personal computer. A wide variety of suitable techniques may be utilized as desired to output testing information. For example, testing information may be communicated to the self-certification server 110 via one or more service provider networks (e.g., a cable network, a cellular network, etc.) and/or other suitable networks. As another example, testing information may be output via a suitable communications interface (e.g., a USB interface, an Ethernet interface, a Bluetooth interface, etc.) for receipt by an external device. As desired, an external device may process at least a portion of the testing information and generate one or more reports and/or messages associated with the RF connection. For example, one or more reports containing diagnostics information for the RF connection and/or information associated with any number of identified errors may be generated. In certain embodiments, reports and/or messages may be returned to the self-certification device 105 for presentation (e.g., display or other output) to a user of the self-certification device 105. In this regard, a user may receive status information associated with the tested RF connection. In other embodiments, reports and/or messages may be presented to a user by an external device. For example, a user may utilize a personal computer to generate and view report information.

The method 300 may end following block 335.

FIG. 4 is a flow diagram of an example method 400 for testing downstream channels associated with a radio frequency connection, according to an example embodiment of the invention. In certain embodiments, the method 400 illustrates one example of the operations that may be performed at block 315 illustrated in FIG. 3. As such, the method 400 may be performed by a suitable self-certification device, such as the self-certification device 105 illustrated in FIG. 1 or the self-certification devices 200, 250 illustrated in FIGS. 2A-2B.

The method 400 may be utilized to collect information and/or to test a plurality of downstream channels identified by the self-certification device 105. For example, the self-certification device 105 may be utilized to scan a plurality of downstream channels received via an RF connection, and the method 400 may be utilized to collect information associated with each of the plurality of downstream channels. A wide variety of information may be collected for each of the downstream channels. Additionally, information for a downstream channel may be collected for a wide variety of different communication layers or other levels associated with the channel. In this regard, any errors may be triggered at an appropriate level or for an appropriate layer to assist in troubleshooting procedures. The method 400 may begin at block 405.

At block 405, a next downstream channel may be selected for processing. For example, a next available downstream channel identified during a scan of downstream frequencies received via the RF connection may be selected. At block 410, a determination may be made as to whether the end of the downstream channels has been reached. If it is determined at block 410 that the end of the downstream channels has been reached, then operations may end. If, however, it is determined at block 410 that the end of the downstream channels has not been reached, then operations may continue at block 415.

At block 415, a modulation mode associated with the selected downstream channel may be identified. A wide variety of different types of modulation modes may be identified as desired in various embodiments of the invention. These modulation modes may include analog and/or digital modulation modes. Examples of suitable modulation modes that may be identified for a cable connection include, but are not limited to, an Amplitude Modulation-Vestigial Side-Band (“AM-VSB”) modulation mode, a Quadrature Amplitude Modulation (“QAM”) mode, and/or a Quadrature Phase-Shift Keying (“QPSK”) modulation mode, a time division multiple access (“TDMA”) modulation mode (e.g., a Global System for Mobile Communications (“GSM”) modulation mode, etc.), a code division multiple access (“CDMA”) modulation mode, an orthogonal frequency-division multiplexing (“OFDM”) modulation mode, an International Mobile Telecommunications/Long Term Evolution (“IMT/LTE”) modulation mode, or an Institute of Electrical and Electronics Engineers (“IEEE”) 802-based modulation mode. In certain embodiments, a modulation mode may be identified based upon header information included in data received via the downstream channel. As a result of determining a modulation mode, the self-certification device 105 may determine or identify a wide variety of parameters associated with a data stream carried by the downstream channel. In other words, the self-certification device 105 may identify an expected format for the downstream channel. As desired, a wide variety of modulation mode information may be identified and utilized to test the downstream channel, such as a signal level, a signal to noise ratio, a modulation error ratio, and/or a carrier to noise ratio.

At block 420, a type of error correction associated with the selected downstream channel may be identified. A wide variety of suitable techniques may be utilized to identify a type of error correction associated with the downstream channel. For example, header information and/or various checksums may be utilized to identify a type of error correction. Additionally, a wide variety of different types of error correction may be associated with a downstream channel and identified by the self-certification device 105. Examples of suitable error correction techniques include, but are not limited to, an interleaving error correction technique and/or a Reed-Solomon error correction technique. Once an error correction technique has been identified, the self-certification device 105 may utilize the error correction technique to test data received via the download channel in order to identify any errors in the data.

At block 425, the self-certification device 105 may identify an operational mode associated with the selected downstream channel. For example, an operational mode may be determined based upon an analysis of header information and/or based upon the identification of a modulation mode. The operational mode may be utilized to determine the formatting of information included in the downstream channel. A wide variety of suitable operational modes may be identified as desired in various embodiments. Example operational modes for a cable downstream channel include, but are not limited to, a DOCSIS operational mode and/or a SCTE operational mode, such as an SCTE 55-1 operational mode or an SCTE 55-2 operational mode. Additionally, in certain embodiments, an out of band operational mode may be determined. The out of band operational mode may be utilized in certain embodiments to identify one or more potential upstream channels.

At block 430, one or more transport stream layers associated with the downstream channel may be identified. Information associated with the transport stream layers may be utilized to identify the types of transport streams or data streams included in the downstream channel. A wide variety of different types of transport stream layers may be identified as desired in various embodiments of the invention. For example, a Moving Picture Experts Group 2 (“MPEG-2”) transport stream may be identified. As another example, circuit switched telephony signals may utilize a proprietary transport stream layer that is identified.

At block 435, one or more data streams included in the downstream channel may be identified. In certain embodiments, the data streams may include audio and/or video data streams corresponding to various programs; however, other types of data streams, such as telephony data streams and/or Internet data streams, may be identified. A wide variety of different techniques and/or methods may be utilized as desired to identify data streams. For example, packets of data included in the various data streams may include packet identifiers that are utilized to map the data to the relevant data streams. Information included in the packet identifiers, such as a program identifier and/or a packet stream identifier, may be utilized in conjunction with a program address table and/or a program map table to identify one or more data streams. As another example, a defined protocol for SCTE 55 data streams may be utilized to identify and test the data streams.

At block 440, one or more data stream parameters may be identified or determined. The data stream parameters may include parameters associated with expected types of data included in the data stream, such as encoding parameters, encryption parameters, access parameters, and/or definitions of data structures. Indeed, a wide variety of different types of data stream parameters may be identified. Data stream parameters may be identified utilizing a wide variety of different sources of information, such as data included in the downstream channel, data obtained from a central server, and/or data stored in a memory of the self-certification device. At block 445, a determination may be made as to whether one or more parameters associated with a data stream (e.g., access parameters, signal parameters, expected data structure parameters, etc.) are satisfied by the data included in the data stream. In this regard, a determination may be made as to whether the data stream is properly received via the RF connection. If it is determined at block 445 that the one or more data stream parameters are satisfied, then operations may continue at block 405 and a next downstream channel may be selected for testing. If, however, it is determined at block 445 that one or more parameters are not satisfied, then operations may continue at block 450. At block 450, an error associated with the data stream may be identified, and information associated with the error may be stored. Operations may then continue at block 405, and a next downstream channel may be selected for testing.

At each level or layer of a downstream data channel identified and tested by the self-certification device 105, the self-certification device 105 may determine whether various parameters associated with the level or layer are satisfied in a similar manner as that described above with reference to block 440. In this regard, any identified errors may be associated with a layer that triggered the error, thereby assisting in a subsequent trouble-shooting procedure.

The method 400 may end following block 410.

FIG. 5 is a flow diagram of an example method 500 for testing upstream channels associated with a radio frequency connection, according to an example embodiment of the invention. In certain embodiments, the method illustrates one example of the operations that may be performed at blocks 320-330 of FIG. 3. As such, the method 500 may be performed by a suitable self-certification device, such as the self-certification device 105 illustrated in FIG. 1 or the self-certification devices 200, 250 illustrated in FIGS. 2A-2B. The method 500 may begin at block 505.

At block 505, one or more potential upstream data channels or out of band data channels may be identified. In certain embodiments, information associated with processed downstream channels may be utilized to identify potential upstream channels. For example, if one or more downstream channels are DOCSIS channels, then one or more DOCSIS Set-top Gateway (“DSG”) channels may be identified as potential upstream data channels. In other words, the self-certification device 105 may scan DOCSIS upstream channels in an attempt to identify one or more DSG tunnels. As another example, if one or more downstream channels are SCTE channels, then one or more out of band SCTE channels (e.g., SCTE 55-1 channels, SCTE 55-2 channels, etc.) may be identified as potential upstream channels. In certain embodiments, data included in the downstream channels may reference or identify upstream channels to be utilized. In other embodiments, the self-certification device 105 may identify potential upstream channels based upon an identification of the different types of downstream channels. Additionally, in certain embodiments, the potential upstream channels may utilize different frequencies than the downstream channels. For example, upstream channels in a cable network may utilize a frequency range between approximately five (5) megahertz and approximately fifty (50) megahertz, although other frequency ranges may be utilized as desired.

At block 510, a next potential upstream channel may be selected for testing. At block 515, a determination may be made as to whether the end of the potential upstream channels has been reached. If it is determined at block 515 that the end of the potential upstream channels has been reached, then operations may end. If, however, it is determined at block 515 that the end of the potential upstream channels has not been reached, then operations may continue at block 520.

At block 520, the self-certification device 105 may attempt to establish communication with one or more central servers, such as the one or more service provider head end systems 125 illustrated in FIG. 1, via the selected upstream channel. In certain embodiments, the self-certification device 105 may attempt to log onto a central server in a set-top emulation mode. In other words, the self-certification device 105 may attempt to emulate the processing of a set-top box in an attempt to establish communication with a central server.

At block 525, a determination may be made as to whether communication with the one or more central servers may be established for the selected upstream channel. For example, a determination may be made as to whether the self-certification device 105 was able to access one or more central servers in a set-top emulation mode using the selected potential upstream channel. If it is determined at block 525 that communications have not been established, then operations may continue at block 530, and a communication error may be identified. As desired, any number of additional attempts may be made to establish communications via the potential upstream channel. In the event that communications cannot be established, operations may then continue at block 510, and a next potential upstream channel may he selected for testing.

lf, however, it is determined at block 525 that communications with one or more central servers have been established, then operations may continue at block 535, and the availability of any number of user applications or client applications may be tested. Examples of applications that may be tested for a cable RF connection include, but are not limited to, an electronic program guide application, a video on demand application, a switched digital video application, a mini-carousel application, an Internet television application, and/or a benchmark application. At block 535, a next user application may be selected for testing. At block 540, a determination may be made as to whether the end of the applications has been reached. If it is determined at block 540 that the end of the applications has been reached, then operations may continue at block 510, and a next potential upstream channel may be selected for testing. If, however, it is determined at block 540 that the end of the applications has not been reached, then operations may continue at block 545.

At block 545, a determination may be made as to whether the selected application is available. In other words, a determination may be made as to whether the self-certification device 105 is able to communicate with an application server (e.g., a head end system server) in order to access the selected application. In addition to testing whether an application is available, the self-certification device 105 may determine whether any number of application parameters, such as timing parameters (e.g., timing parameters to compile electronic program guide data, etc.) and/or access parameters within the application are satisfied. In this regard, the self-certification device 105 may determine whether a user would be able to fully utilize the application in the event that a set-top box or other device were utilized in conjunction with the RF connection being tested.

If it is determined at block 545 that the application is not available and/or that any number of application parameters have not been satisfied, then operations may continue at block 550. At block 550, an application error may be identified, and information associated with the identified error may be stored and/or communicated to an external device for report generation purposes. Operations may then continue at block 535, and a next application may be selected for testing. If, however, it is determined at block 545 that the application is available and functioning properly, then operations may continue at block 555. At block 555, the availability of the application via the selected upstream channel may be verified. Operations may then continue at block 535, and a next application may be selected for testing.

The method 500 may end following block 515.

As desired in various embodiments, once the upstream channels have been tested, the self-certification device 105 may log out or exit a set-top emulation mode. The self-certification device 105 may then establish or reestablish communication with the self-certification server 110, and the self-certification device 105 may communicate testing data to the self-certification server 110. In this regard, reports may be generated by the self-certification server 110, and reporting and/or status information associated with the RF connection may be returned to the self-certification device 105 for display or other presentation to a user. Similarly, the self-certification device 105 may communicate testing data to another external device (e.g., a personal computer) for diagnostics and/or report generation purposes. In other embodiments, the self-certification device 105 may generate reports internally.

Additionally, in certain embodiments of the invention, a self-certification device 105 may be operated in a paired mode in order. to test local connections, such as MoCA connections between various RF terminals within a home or other structure. For example, a user may connect a plurality of self-certification devices to various RF terminals, and the devices may operate in a paired mode in an attempt to establish communication among one another to test the local connections.

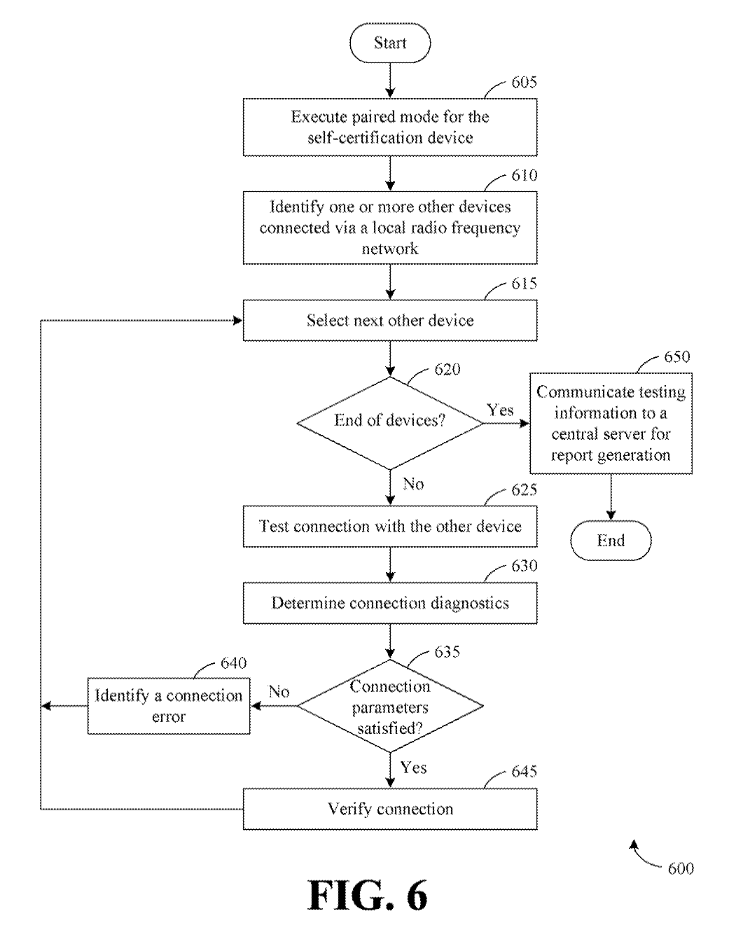

FIG. 6 is a flow diagram of an example method 600 for testing interactivity with other devices via a local radio frequency network, according to an example embodiment of the invention. In certain embodiments, the method 600 may be performed by a suitable self-certification device, such as the self-certification device 105 illustrated in FIG. I or the self-certification devices 200, 250 illustrated in FIGS. 2A-2B. The method 600 may begin at block 605.

At block 605, a paired mode may be executed or entered for the self-certification device 105. For example, a paired mode may be executed for a self-certification device 105 connected to an RF terminal. As desired, a paired mode may also be executed for any number of other self-certification devices connected to other RF terminals in communication with the self-certification device 105 via any number of local networks, such as an in-home MoCA network.

As another example, a paired mode may be executed for any number of self-certification devices configured to communicate locally via a mesh network. For example, cellular mesh networking connectivity may be tested without access to cell towers and/or base stations. In the event that a paired mode is utilized to test a wireless RF connections, testing operations may be similar to those described in the blocks below for a wired connection.

At block 610, one or more other devices connected via a local RF network, such as an in-home MoCA network, may be identified by the self-certification device 105. At block 615, a next device may be selected for testing. At block 620, a determination may be made as to whether the end of the other devices has been reached. If it is determined at block 620 that the end of the other devices has been reached, then operations may continue at block 650 described in greater detail below. If, however, it is determined at block 620 that the end of the other devices has not been reached, then operations may continue at block 625.

At block 625, a connection between the self-certification device 105 and the selected other device may be tested. In other words, a determination may be made as to whether network connectivity may be established with the other device. Additionally, at block 630, any number of connection diagnostics may be determined, such as signal strength of a connection, timing information associated with a connection, and/or various benchmark data associated with an established connection. Indeed, a wide variety of different diagnostic data may be obtained in order to test a communication with a paired device.

At block 635, a determination may be made as to whether one or more connection parameters are satisfied. For example, a determination may be made as to whether one or more diagnostic thresholds for the connection are satisfied, such as a signal strength threshold and/or various timing thresholds. If it is determined at block 635 that one or more connection parameters have not been satisfied, then operations may continue at block 640, and a connection error may be identified. In this regard, a communication error between an RF terminal associated with the self-certification device 105 and an RF terminal associated with the paired device may be identified. Operations may then continue at block 615, and a next paired device may be selected for testing. If, however, it is determined at block 635 that the applicable connections parameters are satisfied, then operations may continue at block 645, and a connection between the self-certification device 105 and the paired device may be verified. Operations may then continue at block 615, and a next paired device may be selected for testing.

Once all of the paired devices have been tested, operations may continue at block 650. At block 650, which may be optional in certain embodiments of the invention, testing information associated with the identified paired devices may be communicated to a central server, such as the self-certification server 110, or to another external device. In this regard, the testing information may be processed, and/or one or more reports associated with the testing information may be generated. Generated reports, report messages, and/or other messages may be returned to the self-certification device 105 for presentation to a user of the self-certification device 105. In this regard, the user may ascertain whether local connections are functional between various radio frequency terminations (e.g., cable outlets) within a tested structure.

The method 600 may end following block 650.

The operations described and shown in the methods 300, 400, 500, and 600 of FIGS. 3-6 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 3-6 may be performed.

Various block and/or flow diagrams of systems, methods, apparatus, and/or computer program products according to example embodiments of the invention are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A device configured to test a radio frequency connection, the device comprising:
at least one radio frequency communications interface;
at least one memory configured to store computer-executable instructions; and
at least one processor configured to access the at least one memory and execute the computer-executable instructions to (i) scan through a plurality of downstream frequencies received by the communications interface, (ii) collect, based at least in part upon the scan, information associated with a plurality of downstream channels and information associated with available upstream channels, (iii) identify one or more upstream channels that facilitate communication with a host server, and (iv) verify, via the one or more identified upstream channels, the availability of one or more client applications.

2. The device of claim 1, wherein the radio frequency communications interface comprises one of (i) a coaxial cable interface or (ii) an antenna.

3. The device of claim 1, wherein the at least one processor is configured to collect information associated with one of the plurality of downstream channels by executing the computer-executable instructions to:
identify a modulation mode associated with the downstream channel;
identify one or more transport stream layers associated with the downstream channel;
identify one or more data streams associated with the downstream channel; and
determine whether the one or more data streams satisfy one or more predetermined data stream parameters.

4. The device of claim 3, wherein the identified modulation mode comprises one of (i) an analog Amplitude Modulation-Vestigial Side-Band (AM-VSB) mode, (ii) a digital quadrature phase-shift keying (QPSK) mode, (iii) a digital quadrature amplitude modulation (QAM) mode, (iv) a time division multiple access (TDMA) modulation mode, (v) a code division multiple access (CDMA) modulation mode, (vi) an orthogonal frequency-division multiplexing (OFDM) modulation mode, (vii) an International Mobile Telecommunications/Long Term Evolution (IMT/LTE) modulation mode, or (viii) an Institute of Electrical and Electronics Engineers (IEEE) 802-based modulation mode.

5. The device of claim 3, wherein the identified one or more transport stream layers comprise Moving Picture Experts Group 2 (MPEG-2) transport stream layers.

6. The device of claim 3, wherein the at least one processor is configured to identify one or more data streams by executing the computer-executable instructions to:
identify at least one of a program identifier or a packet stream identifier; and
access one of a program map table or a program association table utilizing the identifier.

7. The device of claim 3, wherein the at least one processor is further configured to execute the computer-executable instructions to:
identify, for the downstream channel, an operational mode for communicating out of band data.

8. The device of claim 7, wherein the identified operational mode comprises one of (i) a Data Over Cable Service Interface Specification (DOCSIS) Set-top Gateway (DSG) operational mode, (ii) a Society of Cable Telecommunications Engineers (SCTE) 55-1 operational mode, or (iii) a SCTE 55-2 operational mode.

9. The device of claim 3, wherein the at least one processor is further configured to execute the computer-executable instructions to:
determine a type of error correction associated with the downstream channel.

10. The device of claim 9, wherein the type of error correction comprises at least one of (i) interleaving or (ii) Reed-Solomon error correction.

11. The device of claim 1, wherein the at least one processor is configured to identify one or more upstream channels by executing the computer-executable instructions to:
determine, based at least in part upon the information associated with the plurality of downstream channels, one or more potential upstream channels;
test each of the one or more potential upstream channels to determine whether communications can be facilitated via the upstream channel; and
identify the one or more upstream channels based at least in part upon the testing.

12. The device of claim 1, wherein the one or more client applications comprise at least one of (i) an electronic program guide application, (ii) a video on demand application, (iii) a switched digital video application, (iv) a mini-carousel application, (v) an Internet television application, or (vi) a benchmark application.

13. The device of claim 1, wherein the at least one processor is further configured to execute the computer-executable instructions to:
direct communication of the testing information to an external device, wherein the external device is configured to utilize at least a portion of the testing information to generate a report for output to a user of the device.

14. The device of claim 13, wherein the external device comprises one of (i) a certification server or (ii) a personal computer.

15. The device of claim 1, wherein the at least one processor is further configured to execute the computer-executable instructions to:
identify another device in communication with the device via a local radio frequency connection; and
determine whether interconnectivity is available between the device and the other device.

16. The device of claim 1, wherein the local radio frequency connection comprises a Multimedia over Coax Alliance (MoCA) connection.

17. A method for testing a radio frequency connection, the method comprising:
scanning, by a certification device, a plurality of downstream frequencies received via a radio frequency interface;
collecting, by the certification device based at least in part upon the scanning, information associated with a plurality of downstream channels and information associated with available upstream channels;
identifying, by the certification device, one or more upstream channels that facilitate communication with a host server; and
verifying, by the certification device via the one or more identified upstream channels, the availability of one or more client applications.

18. The method of claim 17, wherein collecting information associated with one of the plurality of downstream channels comprises:
identifying a modulation mode associated with the downstream channel;
identifying one or more transport stream layers associated with the downstream channel;
identifying one or more data streams associated with the downstream channel; and
determining whether the one or more data streams satisfy one or more predetermined data stream parameters.

19. The method of claim 17, wherein identifying one or more upstream channels comprises:
determining, based at least in part upon the information associated with the plurality of downstream channels, one or more potential upstream channels;
testing each of the one or more potential upstream channels to determine whether communications can be facilitated via the upstream channel; and
identifying the one or more upstream channels based at least in part upon the testing.

20. The method of claim 17, wherein verifying the availability of one or more client applications comprises verifying the availability of at least one of (i) an electronic program guide application, (ii) a video on demand application, (iii) a switched digital video application, (iv) a mini-carousel application, (v) an Internet television application, or (vi) a benchmark application.

21. The method of claim 17, further comprising:
identifying, by the certification device, another device in communication with the certification device via a local radio frequency connection; and
determining whether interconnectivity is available between the device and the other device.

22. A method for utilizing a certification device to test a radio frequency connection, the method comprising:
connecting the certification device to a radio frequency port;
utilizing the certification device to scan a plurality of downstream frequencies received via the radio frequency port and to collect, based at least in part upon the scan, information associated with a plurality of downstream channels and information associated with available upstream channels; and
utilizing the certification device to verify the availability of one or more client applications via the available upstream channels.
